(19) United States
(12) Patent Application Publication
(10) Pub. No.: US 2008/0099162 A1
(43) Pub. Date: May 1, 2008

(54) Window Blind Lock and Method

(76) Inventor: Larry Ayers, Saskatoon (CA)

Correspondence Address: SMART AND BIGGAR, 438 UNIVERSITY AVENUE, SUITE 1500 BOX 111, TORONTO, ON, M5G2K8, US

(21) Appl. No.: 11/554,791

(22) Filed: Oct. 31, 2006

(51) Int. Cl. E06B 9/324

(52) U.S. Cl. 160/178.2

(57) ABSTRACT

A window blind lock assembly includes a dog pivotally mounted in a casing to prevent movement of a blind string relative to the casing. The dog is resiliently biased to lock the string in the casing. A lever is pivotally mounted in the casing, and coupled to the dog and string. As the string is pulled, the lever rotates the dog to release the string. Conveniently, the string need not be pulled in any specific direction to release the dog.

### FIELD OF THE INVENTION

The present invention relates generally to window blinds, and more particularly to a blind lock for locking adjustable blinds, such as Venetian blinds, pleated shades, roman shades or similar window blinds in position.

### BACKGROUND OF THE INVENTION

Window blinds formed of string suspended parallel slats or fabrics carried by two or more string assemblies are commonly referred to as Venetian blinds or pleated shades. Such blinds may be raised or lowered by pulling the string assemblies upward or allowing them to extend downward. Gravity pulls the blind material, be it slats or fabric downward and provides tension in the string assemblies. At the same time, in order to keep the blinds in a retracted (upward) position, the string assembly needs to be locked in place.

Numerous blind locking mechanisms are known. For example, U.S. Pat. Nos. 2,010,286 and 2,308,291, and US Patent Publication No. 2005/0056384 all disclose typical blind locks. Many known mechanisms, however are difficult to maintain in their locked state, or are difficult or awkward to release from their locked state. For example, most assemblies require the string to move left or right or forward or aft in order to release or lock the mechanism.

Accordingly there is a need for an effective blind locking mechanism.

### SUMMARY OF THE INVENTION

In accordance with an embodiment of the present invention, a window blind lock assembly includes a dog pivotally mounted in a casing to prevent movement of a blind string relative to the casing. The dog is resiliently biased to lock the string in the casing. A lever is pivotally mounted in the casing, and coupled to the dog and string. As the string is pulled, the lever rotates the dog to release the string. Conveniently, the string need not be pulled in any specific direction to release the dog.

In accordance with an embodiment, there is provided a method of lowering a blind retained by at least one vertically moveable string that passes through a locking apparatus that is released by tension in the string. The method includes applying tension on the string sufficient to release the locking assembly, and less than the tension caused by the weight of the blind, and guiding the blind to a desired vertical position.

In accordance with yet another embodiment there is provided a blind lock assembly, for guiding a string therethrough. The locking assembly comprises: a casing; a dog pivotally mounted in the casing, and comprising a surface for retaining the string between the dog and a guide surface, to prevent movement of the string relative to the casing. The dog resiliently biased to engage the string against the guide surface. The lever is pivotally mounted in the casing, coupled to the dog to rotate the dog to release the string on the guide surface as the lever is pivoted. The lever is coupled to the string, so that tension in the string rotates the lever to rotate the dog to release the string.

Other aspects and features of the present invention will become apparent to those of ordinary skill in the art upon review of the following description of specific embodiments of the invention in conjunction with the accompanying figures.

### BRIEF DESCRIPTION OF THE DRAWINGS

In the figures which illustrate by way of example only, embodiments of the present invention,

FIGS. 1A and 1B are perspective views of window blinds exemplary of embodiments of the present invention;

FIG. 2 is a partial cut-away, perspective view of a blind lock assembly, exemplary of an embodiment of the present invention;

FIG. 3 is a cross-sectional view of the blind lock assembly of FIG. 2 along lines III-III; and

FIGS. 4 and 5 are top plan, cut-away views of the blind lock assembly of FIG. 2.

### DETAILED DESCRIPTION

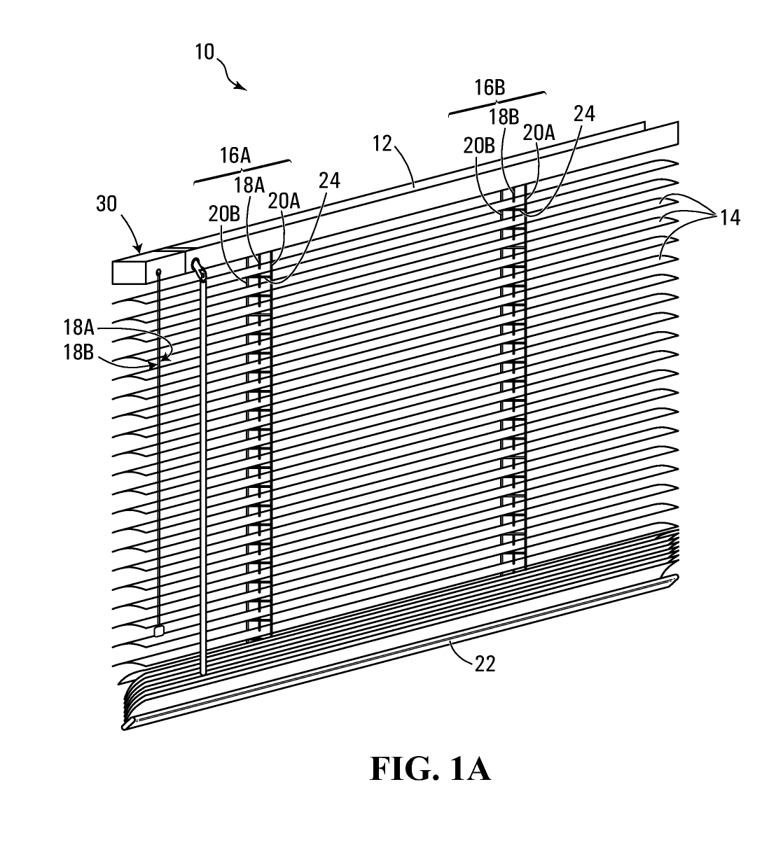

FIG. 1A illustrates a window blind assembly 10 exemplary of an embodiment of the present invention. The illustrated embodiment includes a Venetian window blind, formed of a plurality of laterally extending slats 14. Slats 14 are suspended by two parallel running carrier string assemblies 16A and 16B suspended from a head rail 12.

Each string assembly 16A, 16B includes a front and rear string 20A, 20B, front and aft of a center string 18A, 18B. Each center string 18A, 18B passes through one hole of each slat 14. Small laterally extending strings or straps 24 laterally interconnect front and rear strings 20A, 20B under slats 14, and support slats 14. The bottom of each string assembly 16A, 16B supports the bottom most one of slats 14, also referred to as a bottom rail 22. String assembly 16B is identical to string assembly 16A, and is located proximate the opposite lateral end of slats 14. As the bottom rail 22 is raised and lowered slats 14 are accordingly raised and lowered. To this end, strings 18A and 18B of assemblies 16A and 16B are connected to the bottom rail at their extremity and pass unconnected up through the string assembly into the head rail 12, and right or left as the case may be, into a blind lock assembly 30, exemplary of an embodiment of the present invention.

As will become apparent, lock assembly 30 may form part of a large variety of alternative string and blind arrangements known to those of ordinary skill.

Slats 14 may be locked in a non-extended position, by way of a blind lock assembly 30. Blind lock assembly 30 is fixedly mounted relative to slats 14, for example on or within head rail 12 at the top of window blind arrangement 10.

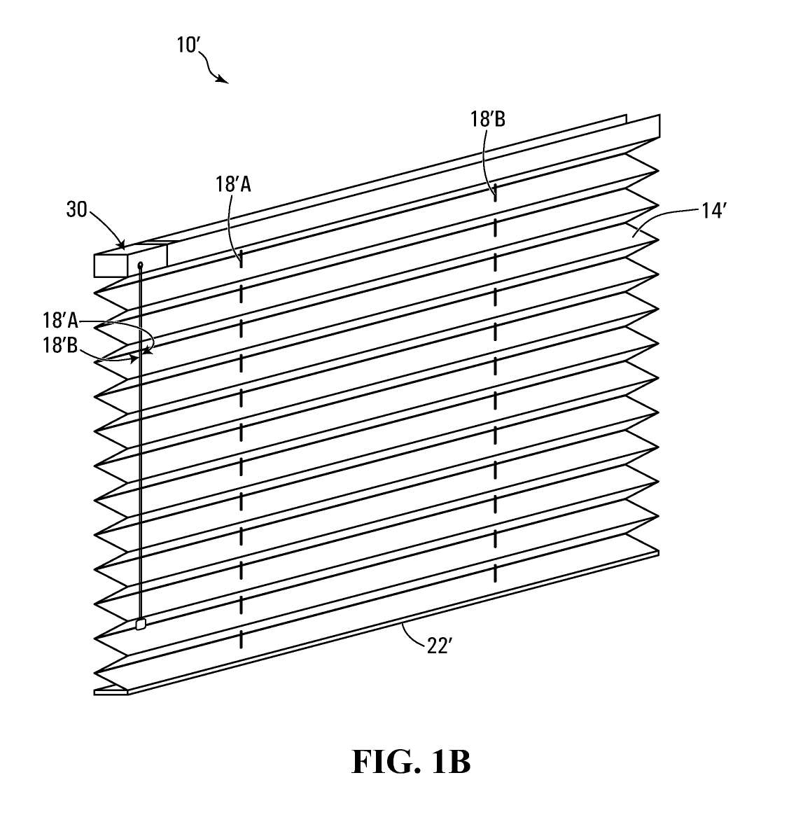

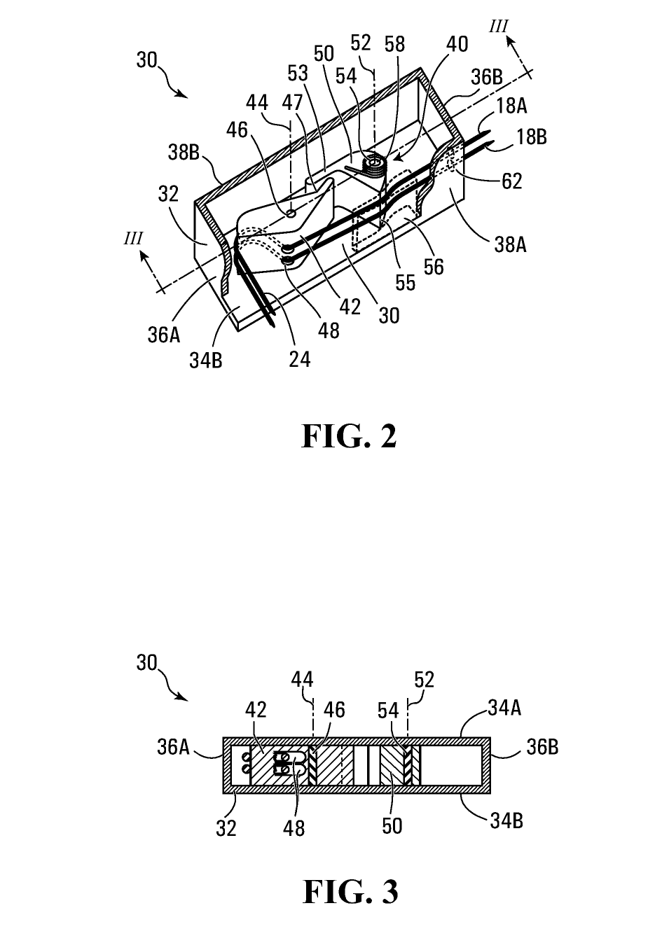

Blind lock assembly 30 is further depicted in FIGS. 2-5. As, for example, illustrated in FIGS. 2 and 3, lock assembly 30 includes a generally rectangular casing 32. Casing 32 may be integral with head rail 12, or may otherwise be separately formed. Casing 32 has opposed generally planar top and bottom walls 34A, 34B (individually and collectively, walls 34) and generally parallel planar sidewalls 36a, 36B and front and aft walls 38a, 38b extending perpendicular to top and bottom walls 34A, 34B along the width of casing 32. Casing 32 may be formed of any suitable material, including plastic, wood, or even metal.

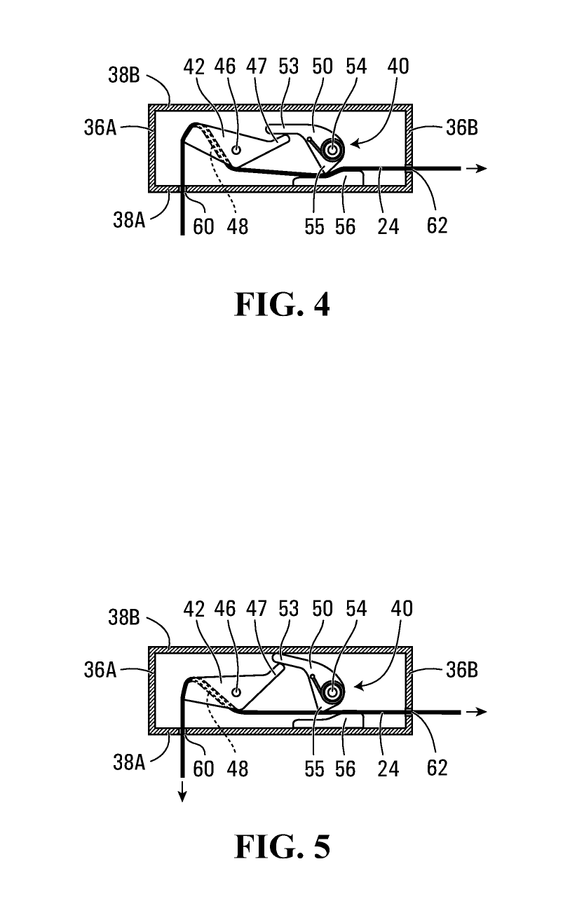

Front wall 38A and sidewall 36B include respective entrance and exit apertures 60 and 62 for guiding strings 18A and 18B into and through casing 32, as best illustrated in FIGS. 4 and 5. Aperture 60 may be formed as a single opening, while aperture 62 may be formed as two separate openings, one for each string 18A and 18B. Of course, any number of suitably sized openings may be appropriate.

A locking mechanism 40 (FIG. 2) is mounted within casing 32. Locking mechanism 40 has two states. In a locked state, illustrated in FIG. 4, strings 18A and 18B cannot move through casing 32. In an unlocked state, illustrated in FIG. 5, strings 18A and 18B may move through casing 32.

Locking mechanism 40 includes a lever 42 that is pivotally mounted about an axis 44 in casing 32, between top and bottom walls 34A, 34B. Lever 42 may, for example, be mounted about a pivot pin 46 extending between, and normal to, opposing walls 34A and 34B. Strings 18A and 18B continue from sidewall 36a through guide 48 in lever 42, on a first side of pivot pin 46, more proximate entrance aperture 60 than exit apertures 62. Guides 48 extend within the body of lever 42.

Guides 48 may be formed of multiple pathways as illustrated in FIG. 3. Individual apertures 62 each guide one of multiple strings 18A, 18B through lock assembly 30 parallel to each other. Conveniently, this prevents multiple strings 18A, 18B running through lock assembly 30 from twisting in the lock assembly 30. Guides 48 and apertures 62 allowing precise positioning of the strings.

As will become apparent, strings 18A and 18B are pulled by an operator they are put in tension and a linear force is exerted on lever 42, causing it to pivot about pivot pin 46. Lever 42 further includes an engagement surface 47, on the other side of pivot pin 46. The direction of rotation of lever 42 will depend on the location of lock assembly 30 relative to strings 18A. For example, if assembly is mounted as depicted in FIG. 1, strings 18A, 18B enter lock assembly 30 from the left and exit from the right side of lock assembly 30. Lever 42 will accordingly rotate counter clockwise as strings 18A and 18B are pulled downward. If strings 18A, 18B exit from the left side, lever 42 will rotate clockwise.

A dog 50 is similarly mounted within casing 32 about an axis 52 parallel to axis 44 on a pivot pin 54. Dog 50 is proximate lever 42, and includes an engagement surface 53 on one side of axis 52, proximate lever 42, and a further friction/pinching surface 55. Engagement surface 53 is in contact with engagement surface 47 of lever 42. A guide surface 56 is formed along wall 38a, to guide strings 18A and 18B from lever 42 in a direction generally parallel to wall 38a, along the length of locking mechanism 40 and adjacent to dog 50. Guide surface 56 further serves as surface against which friction/pinching surface 55 of dog 50 impinges to secure strings 18A, 18B in a locked position. In the exemplary embodiment, friction/pinching surface 55 is formed as pinching edge, as a cusp, on dog 50, while guide surface 56 is generally smooth. Of course, friction/pinching surface 55 or guide surface 56 at point of contact, or both, could alternatively be formed as a series of serrations or as rough surfaces such as unfinished ceramic, plastic or other surfaces.

Dog 50 is resiliently biased by a resilient biasing member 58 to pivot in the counter-clockwise direction (and clockwise for a blind lock mounted at the opposite end of the head rail 12), so that friction/pinching surface 55 of dog 50 is forced proximate to, and to impinge on, guide surface 56 to wedge strings 18, absent an external applied force. Resilient biasing member 58 may be a metal spring or rubber or plastic bumper or band, or any other suitable biasing member known to those of ordinary skill.

As will now also be appreciated, lever 42 and dog 50 (including any engaging surfaces) may have a wide variety of shapes other than those exemplified herein.

Strings 18A and 18B enter casing 32 by way of aperture 60 in wall 38A and exit to slats 14 (FIG. 1) of blind assembly 10 by way of apertures 62 in sidewall 36B. Strings 18A and 18B extend over the front lip of lever 42, through guide 48, and along the bottom of lever 42. Strings 18A and 18B are thus in contact with lever 42, and when pulled exert a rotational force on lever 42 as it passes through guide 48. As a consequence, as strings 18A and 18B are pulled toward aperture 60 of front wall 38a, lever 42 is pivoted counter-clockwise about axis 44. As lever 42 is rotated, engagement surface 47 engages a complementary engagement surface 53 of dog 50, causing dog 50 to pivot clockwise, forcing surface 55 away from, and out of engagement with surface 56, as best depicted in FIG. 5. Once surface 55 is pivoted into this position, any friction applied by surface 55 on strings 18A and 18B is released, placing locking mechanism in its unlocked state, allowing for generally unimpeded passage of strings 18A and 18B, along guide surface 56, and through lock assembly 30.

Releasing tension on strings 18A and 18B, allows lever 42 to pivot clockwise, removing applied force on engagement surface 53 of dog 50. Dog 50 similarly rotates counter-clockwise, thereby pinching strings 18A and 18B between friction/pinching surface 55 of dog 50 and guide surface 56, as best illustrated in FIG. 4. The resulting friction, in turn, prevents strings 18A and 18B from moving further along guide surface 56, thereby locking strings 18A and 18B in place, relative to casing 32.

As will now be appreciated, lock assembly 30 is released by pulling strings 18A and 18B through the aperture 60. Releasing tension on strings 18A and 18B, in turn, causes lock assembly 30 to pivot into its locked position, crimping or wedging strings 18A and 18B between surfaces 56 and 55, retaining strings 18A and 18B in their current position. Tension on strings 18A and 18B to maintain lock assembly 30 in its locked state with dog 50 engaging surface 56) is maintained by the weight of blind material (i.e. slats 14 of FIG. 1A).

Conveniently, a single pull on the strings 18A and 18B to provide some forward force is sufficient to overcome the resilient bias applied by biasing member 58, releasing dog 50 and freeing strings 18A and 18B. Slats 14 may be raised or lowered. Once the desired height of the blind is achieved the operator need only drop strings 18A and 18B to lock the blind. Once tension in strings 18A and 18B is released, the bias of resilient member 58 causes dog 50 to pinch strings 18A and 18B, locking them and slats 14 in place.

Accordingly, in operation, the blind, formed of slats 14 may be raised by merely placing some force on strings 18A and 18B, and then raising the blind (i.e. slats 14). Force may be applied by pulling strings 18A and 18B in any direction including downwards, or to either side. Once the blind (i.e. slats 14) is in the desired position, merely releasing strings 18A and 18B will keep the blind in position. On the other hand, in order to lower the blind, a gentle pull, less than the weight of slats 14, may be applied on strings 18A and 18B sufficient to pivot lever 42 to release dog 50. Thereafter the weight of the slats 14 will cause the slats 14 to descend to the desired position. The operator need only apply sufficient force equal to the weight of the blind formed of slats 14 to move the blind to its desired position. Thereafter the operator need only drop the strings 18A and 18B to lock the strings in their position.

As should now be appreciated, lock assembly 30 need not be used with a Venetian blind, but could instead form part of a wide variety of other blinds, exemplary of embodiments of the present invention. For example, locking assembly could form part of a pleated blind assembly 10′, as illustrated in FIG. 1B. Strings 18′ are thus used to raise a lower a blind formed of pleated fabric 14′. Lock assembly 30′ of blind assembly 10′ may function as described with reference to blind assembly 10 of FIG. 1.

Similarly, blind assembly 10 may be formed with an arbitrary number of parallel string assemblies, like string assemblies 16A, 16B. Accordingly, lock assembly 30 could be formed with more (or fewer) than two apertures 62, and corresponding guides 48. One or three or more strings could be locked by lock assembly 30. Optionally, multiple individual strings could be tied or woven into a single string for locking by lock assembly 30.

As should now be appreciated, the term string as used herein is used to refer to any string or string like member used to raise or lower blinds. As such, in suitable embodiments strings 18 could be replaced with ropes, chains, or cords formed of string, nylon, metal, plastic beads or the like.

As will also be appreciated, the terms front, aft, top, bottom and side are relative. Lock assembly 30 could, for example, be rotated about a central axis, perpendicular to axes 44 and 52.

Of course, the above described embodiments are intended to be illustrative only and in no way limiting. The described embodiments of carrying out the invention are susceptible to many modifications of form, arrangement of parts, details and order of operation. The invention, rather, is intended to encompass all such modification within its scope, as defined by the claims.

What is claimed is:

1. A blind lock assembly, for guiding a string therethrough, said locking assembly comprising:
a casing;
a dog pivotally mounted in said casing, and comprising a surface for retaining said string between said dog and a guide surface, to prevent movement of said string relative to said casing;
said dog resiliently biased to engage said string against said guide surface;
a lever pivotally mounted in said casing, coupled to said dog to rotate said dog to release said string on said guide surface as said lever is pivoted;
said lever coupled to said string, so that tension in said string rotates said lever to rotate said dog to release said string.

2. The assembly of claim 1, wherein said guide surface is formed within said casing.

3. The assembly of claim 1, wherein said casing comprises a front wall and an entrance aperture for said string on said front wall.

4. The assembly of claim 3, wherein said casing comprises a sidewall, generally perpendicular to said front wall, said sidewall comprising an exit aperture for said string.

5. The assembly of claim 1, wherein said lever is mounted for rotation about a pivot pin, and comprises a guide channel for guiding said string on a first side of said pivot pin.

6. The assembly of claim 5, wherein said lever comprises an engagement surface for engaging said dog, said engagement surface on a second, opposite side of said pivot pin.

7. The assembly of claim 6, further comprising a spring to bias said dog to engage said string against said guide surface.

8. The assembly of claim 1, wherein said surface for retaining comprises a cusp on said dog.

9. The assembly of claim 8, wherein said cusp pinches said string to retain said string between said dog and said guide surface to prevent movement of said string relative to said casing.

10. The assembly of claim 7, wherein said dog is biased for clockwise rotation.

11. The assembly of claim 7, wherein said dog is biased for counter-clockwise rotation.

12. A Venetian blind assembly, comprising a plurality of vertically moveable slats, and the blind lock assembly of claim 1.

13. A window blind assembly, comprising a fabric blind vertically moveable, and the blind lock assembly of claim 1.

14. A method of lowering a blind retained by at least one vertically moveable string that passes through a locking apparatus that is released by tension in said string, said method comprising:
applying tension on said string sufficient to release said locking assembly, and less than the tension caused by the weight of said blind, and
guiding said blind to a desired vertical position.

15. The method of claim 14, wherein said blind comprises a plurality of slats retained by said string.

16. The method of claim 14, wherein said blind comprises a sheet of pleated fabric.

17. The method of claim 14, wherein said lock assembly comprises:
a casing and a dog pivotally mounted in said casing, for pinching and retaining said string between said dog and a guide surface, to prevent movement of said string relative to said casing, said dog resiliently biased to engage said string against said guide surface;
a lever coupled to said dog to move said dog to release said string on said guide surface as said lever is pivoted said lever coupled to said string so that tension on said string moves said lever to release said dog.
